(19) United States
(12) Patent Application Publication
(10) Pub. No.: US 2024/0101802 A1
(43) Pub. Date: Mar. 28, 2024

(54) UPGRADED POLYOLEFIN FOR ELECTRICAL COMPONENTS

(71) Applicant: Borealis AG, Vienna (AT)

(72) Inventors: Tuan Anh Tran, Linz (AT); Hermann Braun, Linz (AT); Philip Knapen, Beringen (BE); Michael Zoesch, Burghausen (DE); Michael Hettrich-Keller, Linz (AT)

(21) Appl. No.: 18/267,214

(22) PCT Filed: Dec. 16, 2021
(86) PCT No.: PCT/EP2021/086203

§ 371 Date: Jun. 14, 2023

(30) Foreign Application Priority Data
Dec. 18, 2020 (EP) 20215519.8

(51) Int. Cl. C08L 23/12; C08K 9/08

(52) U.S. Cl. CPC C08L 23/12; C08K 9/08; C08L 2205/025; C08L 2205/035; C08L 2207/20; C08L 2314/06

(57) ABSTRACT

Polyolefin (PO) compositions derived from post-consumer recyclate (PCR) PO based materials having well balanced properties with regards to electric conductivity, impact performance, stiffness, and workability.

### FIELD OF THE INVENTION

The present invention relates to polyolefin (PO) compositions derived from post-consumer recyclate (PCR) PO based materials having well balanced properties with regards to electric conductivity, impact performance, stiffness, and workability.

### BACKGROUND

Recycling of polymers generally distinguishes between physical (comprising mechanical recycling and solvent based recycling) and chemical recycling (comprising depolymerisation, thermolysis, and biodegradation). Prior to the respective recycling steps, the waste is pretreated comprising inter alia shredding the waste and separating different components. Polyolefins, in particular polyethylene and polypropylene, are increasingly consumed in large amounts in a wide range of applications, including fibres, automotive components, and a great variety of manufactured articles.

Polyethylene and polypropylene based materials are a particular problem as these materials are extensively used in packaging. Taking into account the huge amount of waste collected compared to the amount of waste recycled back into the stream, there is still a great potential for intelligent reuse of plastic waste streams and for mechanical recycling of plastic wastes.

Generally, recycled quantities of polypropylene on the market are mixtures of both polypropylene (PP) and polyethylene (PE), this is especially true for post-consumer waste streams. Moreover, commercial recyclates from post-consumer waste sources are conventionally cross contaminated with non-polyolefin materials, such as polyethylene terephthalate, polyamide, polystyrene or non-polymeric substances like wood, paper, glass or aluminum. These cross-contaminations drastically limit final applications of recycling streams such that no profitable final uses remain.

In addition, recycled polyolefin materials normally have properties which are much worse than those of the virgin materials, unless the amount of recycled polyolefin added to the final compound is extremely low. For example, such materials often have limited impact strength and poor mechanical properties (such as e.g. brittleness) and thus, they do not fulfil customer requirements. Further, the workability of recycled polyolefin tends to be worse than that of virgin materials. For several applications, e.g. automotive components, in particular electroconductive components, these limitations exclude the application of recycled materials for high quality parts, and means that they are only used in low-cost, non-demanding applications, such as e.g. in construction or in furniture. In order to improve the mechanical properties of these recycled materials, generally relatively large amounts of virgin materials (produced from oil) are added.

Recently, the amount of electrical components in the car increases, which leads to a high demand for producing electroconductive boxes, crates, and pallets as containers and transporting containers of respective electrical components. A suitable recyclate solution is currently however missing. It is in particular challenging to provide electroconductive boxes, crates, and pallets derived from recycled waste, wherein the properties in terms of electric conductivity, impact performance, stiffness, and workability are well balanced.

EP1776006 relates to extruded or injection molded plastic parts, in particular containers, having an electrical resistance R<10⁸ Ohm, in particular R≤10⁴Ω, characterized in that at least half of the molded part consists of reject material as recycled polyethylene and/or polypropylene comprising at least 10 wt.-% of aluminum. Large amounts of aluminum are however cost-intensive.

EP1439131 relates to an electrostatic-protected container arrangement for transport and storage of flowable materials, comprising a pallet-like base made of an electrically conductive material and an associated protective grille made of an electrically conductive material, which encloses the side walls of the container and whose walls are produced using the blow molding process and consist of at least one layer made of a plastic material with intrinsic electrical properties. Suitable recyclate materials are however not disclosed.

Thus, there remains a need in the art to provide recycled polyolefin solutions for in particular automotive materials that are well balanced in properties such as electric conductivity, impact performance, stiffness, and workability, which are in particular similar to blends of virgin polypropylene and carbon black marketed for said purpose.

It has surprisingly been found that the inventive polyolefin compositions derived from PCR materials comprising non-polyolefins and other contaminant achieve a good level of electric conductivity and mechanical performance, as well as workability.

### SUMMARY OF THE INVENTION

In the broadest aspect the present invention provides a polyolefin composition obtainable by blending
a) 10 to 74 wt.-% of at least one post-consumer recyclate polyolefin based material (PCR-PO1) having a melt flow rate (ISO 1133, 2.16 kg, 230° C.) of 1 to 50 g/10 min and a Volume Resistivity (determined according to ISO 3915 at a temperature of 23° C. and 50% relative humidity) of more than 1800 Ohm·cm,
b) optionally 10 to 50 wt.-% of at least one further, different post-consumer recyclate polyolefin based material (PCR-PO2) having a melt flow rate (ISO 1133, 2.16 kg, 230° C.) of 1 to 50 g/10 min and a Volume Resistivity (determined according to ISO 3915 at a temperature of 23° C. and 50% relative humidity) of more than 1800 Ohm·cm,
c) 25 to 55 wt.-%,
of a carbon black containing polyolefin (CB PO),
d) 1 to 30 wt.-% of at least one C2C4, C2C6, or C2C8 copolymer with a density (determined according to DIN EN ISO 1183) of 860-890 kg/m³ and a melt flow rate (ISO 1133, 2.16 kg, 190° C.) of 0.3 to 35.0 g/10 min,
each based on the total weight of the polyolefin composition,
wherein the polyolefin composition has a Volume Resistivity (determined according to ISO 3915 at a temperature of 23° C. and 50% relative humidity) from 5 to 1400 Ohm·cm,
preferably from 10 to 800 Ohm·cm and a melt flow rate (ISO 1133, 2.16 kg, 230° C.) of 7 to 20 g/10 min, and
wherein the polyolefin composition comprises a total of 10 to 23 wt.-% of carbon black, based on the total weight of the polyolefin composition.

The present invention is based on the surprising finding that a polyolefin composition having well balanced properties with regards to electric conductivity, impact performance, stiffness, and workability is obtained when 25 to 55 wt.-%, based on the total weight of the polyolefin composition, of a carbon black containing polyolefin (CB PO) and 1 to 30 wt.-%, based on the total weight of the polyolefin composition, of a C2C4, C2C6, or C2C8 copolymer are blended with post-consumer recyclate polyolefin based material.

The present invention is further directed to an article, comprising the polyolefin composition, preferably wherein the article is an electroconductive box, a crate, or a pellet.

Also provided are electroconductive boxes, crates, or pellets comprising a polyolefin composition, which is produced from at least one post-consumer recyclate polyolefin based material (PCR-PO1) and more than 20 wt.-% of a carbon black containing polyolefin (CB PO), based on the total weight of the polyolefin composition.

Further, the present invention provides the use of post-consumer recyclate polyolefin based material (PCR-PO) having an aluminum content of less than 10 wt.-% (determined by x ray fluorescence (XRF)), based on the total weight of the post-consumer recyclate polyolefin based material (PCR-PO), for producing electroconductive boxes, crates, or pellets.

### FIGURE LEGEND

FIG. 1 shows a graph illustrating schematically the reduction of Volume Resistivity when increasing the amount of carbon black in a polymer matrix.

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

For the purposes of the present description and of the subsequent claims, the term “recycled waste” is used to indicate a material recovered from both post-consumer waste and industrial waste, as opposed to virgin polymers and/or materials.

“Post-consumer waste” refers to objects having completed at least a first use cycle (or life cycle), i.e. having already served their first purpose; while “industrial waste” refers to manufacturing scrap, which does not normally reach a consumer. According to the present invention, the waste stream is a consumer waste stream, such a waste stream may originate from conventional collecting systems such as those implemented in the European Union. Post-consumer waste material is characterized by a limonene content of from 0.10 to 500 ppm (as determined using solid phase microextraction (HS-SPME-GC-MS) by standard addition). For the purpose of the present description and the subsequent claims, the term “recycled waste polyolefin based material” refers to polyolefin material derived from post-consumer waste and/or industrial waste and wherein the recycled waste polyolefin based material comprises at least 88 wt.-%, preferably at least 92 wt.-%, more preferably at least 96 wt.-%, of polyolefins, based on the total weight of the recycled waste polyolefin based material. For the purposes of the present description and of the subsequent claims, the term “post-consumer recyclate polyolefin based material” (PCR-PO) refers to polyolefin material derived from post-consumer waste and wherein the PCR-PO comprises at least 88 wt.-%, preferably at least 92 wt.-%, more preferably at least 96 wt.-%, of polyolefins, based on the total weight of the PCR-PO, having completed at least a first use cycle (or life cycle), i.e. having already served their first purpose. Post-consumer recyclate polypropylene based material (PCR-PP) refers to polypropylene material comprising at least 80 wt.-% of polypropylene, based on the total weight of the PCR-PP, having completed at least a first use cycle (or life cycle), i.e. having already served their first purpose. Likewise, post-consumer recyclate polyethylene based material (PCR-PE) refers to polyethylene material comprising at least 65 wt.-% of polyethylene, based on the total weight of the PCR-PE, having completed at least a first use cycle (or life cycle), i.e. having already served their first purpose. Post-consumer recyclate polyolefin based material (PCR-PO) may also refer to a blend of two or more different post-consumer recyclate polyolefin based materials (PCR-PO), preferably to a blend of a PCR-PP and PCR-PE. A PCR-PP/PCR-PE blend may have a weight ratio of PP:PE from 20:80 to 80:20.

It should be understood that PCR-PO may vary broadly in composition, i.e. may include polyolefin homopolymers and polyolefin copolymers.

Conventionally the PCR-PO according to the present invention may have one or more of the following:
residual chalk content determined as described below;
residual talc content determined as described below;
residual content of metals (determined by x ray fluorescence (XRF));
residual amount of paper determined as described below;
residual amount of wood determined as described below;
total free fatty acid content of 0.1 to 100 ppm as measured by using headspace solid phase micro-extraction (HS-SPME-GC-MS).

### Talc and Chalk Content:

### TGA According to the Following Procedure:

Thermogravimetric Analysis (TGA) experiments may be performed with a Perkin Elmer TGA 8000. Approximately 10-20 mg of material shall be placed in a platinum pan. The temperature is equilibrated at 50° C. for 10 minutes, and afterwards raised to 950° C. under nitrogen at a heating rate of 20° C./min. The weight loss between about 550° C. and 700° C. (WCO₂) is assigned to CO₂ evolving from CaCO₃, and therefore the chalk content is evaluated as:

Chalk content=100/44×WCO₂

Afterwards the temperature is lowered to 300° C. at a cooling rate of 20° C./min. Then the gas is switched to oxygen, and the temperature is raised again to 900° C. The weight loss in this step is assigned to carbon black (Wcb). Knowing the content of carbon black and chalk, the ash content excluding chalk and carbon black is calculated as:

Ash content=(Ash residue)−56/44×WCO₂−Wcb

Where Ash residue is the weight % measured at 900° C. in the first step conducted under nitrogen. The ash content is estimated to be the same as the talc content for the investigated recyclates.

### Amount of Paper, Wood:

Paper and wood are determined by conventional laboratory methods including milling, flotation, microscopy and Thermogravimetric Analysis (TGA).

For the purpose of this invention any polyolefin based material comprising at least 88 wt.-% of polyolefin, based on the total weight of the polyolefin based material, having a limonene content of from 0.10 to 500 ppm (as determined using solid phase microextraction (HS-SPME-GC-MS) by standard addition) shall be considered a PCR-PO.

For the purpose of this invention the PCR-PO has at least one of the following:
a content of limonene of from 0.10 to 500 ppm, preferably from 0.1 to 100 ppm, more preferably from 0.1 to 50 ppm (as determined using solid phase microextraction (HS-SPME-GC-MS) by standard addition);
a content of polystyrene of up to 6.0 wt.-%;
a content of talc of up to 3 wt.-%;
a content of chalk of up to 1.0 wt.-%;
a content of polyamide(s) of up to 5.0 wt.-%;
a content of fatty acids (as determined using solid phase microextraction (HS-SPME-GC-MS) by standard addition) of 1.0 to 100 ppm.

For the purposes of the present description and of the subsequent claims, the term post-consumer recyclate polyolefin based material (PCR-PO) further indicates a polymer material including predominantly units derived from polyolefins (derived from ethylene, propylene, butylene, octene, and the like) apart from other polymeric ingredients of arbitrary nature. Such polymeric ingredients may for example originate from monomer units derived from styrene derivatives such as vinylstyrene, substituted and unsubstituted acrylates, substituted and unsubstituted methacrylates. Conventionally further components such as fillers, including organic and inorganic fillers for example talc, chalk, carbon black, and further pigments such as TiO₂ as well as paper and cellulose may be present.

Said polymeric materials can be identified in the PCR-PO composition by means of quantitative ¹³C{¹H} NMR measurements as known in the art. Therewith, different units in the polymeric chain can be distinguished and quantified. These units are ethylene units (C2 units), units having 3, 4 and 6 carbons and units having 7 carbon atoms.

Thereby, the units having 3 carbon atoms (C3 units) can be distinguished in the NMR spectrum as isolated C3 units (isolated C3 units) and as continuous C3 units (continuous C3 units) which indicate that the polymeric material contains a propylene based polymer. These continuous C3 units can also be identified as iPP units.

The units having 3, 4, 6 and 7 carbon atoms describe units in the NMR spectrum which are derived from two carbon atoms in the main chain of the polymer and a short side chain or branch of 1 carbon atom (isolated C3 unit), 2 carbon atoms (C4 units), 4 carbon atoms (C6 units) or 5 carbon atoms (C7 units).

The units having 3, 4 and 6 carbon atoms (isolated C3, C4 and C6 units) can derive either from incorporated comonomers (propylene, 1-butene and 1-hexene comonomers) or from short chain branches formed by radical polymerization.

Post-consumer recyclate polyolefin based material(s) as used herein are commercially available. Suitable blends include a number of recyclates available from Mtm plastics under the brand name Purpolen or Dipolen.

The term “virgin” denotes the newly produced materials and/or objects prior to their first use, which have not already been recycled. The term “recycled material” such as used herein denotes materials reprocessed from “recycled waste”. Virgin materials and recycled materials easily can be differentiated based on absence or presence of contaminants such as limonene and/or fatty acids and/or paper and/or wood.

A blend denotes a mixture of two or more components, wherein at least one of the components is polymeric. In general, the blend can be prepared by mixing the two or more components. Suitable mixing procedures are known in the art. The carbon black containing polyolefin (CB PO) exemplarily is a blend comprising a polyolefin and carbon black.

If not indicated otherwise “%” refers to weight-%.

When referred to compositions and the weight percent of the therein comprised ingredients it is to be understood that according to the present invention the overall amount of ingredients does not exceed 100% (±1% due to rounding).

### DETAILED DESCRIPTION

The polyolefin composition according to the present invention is obtainable by blending polyolefin composition obtainable by blending
a) 10 to 74 wt.-% of at least one post-consumer recyclate polyolefin based material (PCR-PO1) having a melt flow rate (ISO 1133, 2.16 kg, 230° C.) of 1 to 50 g/10 min and a Volume Resistivity (determined according to ISO 3915 at a temperature of 23° C. and 50% relative humidity) of more than 1800 Ohm·cm,
b) optionally 10 to 50 wt.-% of at least one further, different post-consumer recyclate polyolefin based material (PCR-PO2) having a melt flow rate (ISO 1133, 2.16 kg, 230° C.) of 1 to 50 g/10 min and a Volume Resistivity (determined according to ISO 3915 at a temperature of 23° C. and 50% relative humidity) of more than 1800 Ohm·cm,
c) 25 to 55 wt.-%,
of a carbon black containing polyolefin (CB PO),
d) 1 to 30 wt.-% of at least one C2C4, C2C6, or C2C8 copolymer with a density (determined according to DIN EN ISO 1183) of 860-890 kg/m³ and a melt flow rate (ISO 1133, 2.16 kg, 190° C.) of 0.3 to 35.0 g/10 min,
each based on the total weight of the polyolefin composition,
wherein the polyolefin composition has a Volume Resistivity (determined according to ISO 3915 at a temperature of 23° C. and 50% relative humidity) from 5 to 1400 Ohm·cm, preferably from 10 to 800 Ohm·cm and a melt flow rate (ISO 1133, 2.16 kg, 230° C.) of 7 to 20 g/10 min, and
wherein the polyolefin composition comprises a total of 10 to 23 wt.-% of carbon black, based on the total weight of the polyolefin composition.

According to the present invention 100 wt.-% of the at least one post-consumer recyclate polyolefin based material (PCR-PO1), as well as of the at least one further, different post-consumer recyclate polyolefin based material (PCR-PO2), originate from post-consumer waste, such as from conventional collecting systems (curb-side collection), such as those implemented in the European Union.

Said post-consumer waste can be identified by its limonene content. It is preferred that the post-consumer waste has a limonene content of from 0.10 to 500 ppm.

It is to be understood that the Volume Resistivity is the reciprocal of electric conductivity. The unit of Volume Resistivity according to the present application is Ohm·cm and is determined according to ISO 3915 at a temperature of 23° C. and 50% relative humidity. A low Volume Resistivity indicates a material that readily allows electric current.

The invention provides said polyolefin composition, wherein the components are blended preferably in the following amounts:
a) from 13 to 71 wt.-%, preferably from 15 to 67 wt.-%, more preferably from 20 to 63 wt.-%, of the at least one post-consumer recyclate polyolefin based material (PCR-PO1),
b) optionally from 13 to 45 wt.-%, preferably from 15 to 40 wt.-%, more preferably from 20 to 30 wt.-%, of the at least one further, different post-consumer recyclate polyolefin based material (PCR-PO2),
c) from 26 to 51 wt.-%, preferably from 28 to 50 wt.-%, more preferably from 29 to 48 wt.-%, of the carbon black containing polyolefin (CB PO),
d) from 3 to 25 wt.-%, preferably from 5 to 20 wt.-%, more preferably from 8 to 15 wt.-%, of the at least one C2C4, C2C6, or C2C8 copolymer,
each based on the total weight of the polyolefin composition.

In one preferred embodiment the present invention provides said polyolefin composition, wherein the components are blended in the following amounts:
a) 20 to 74 wt.-%, preferably from 25 to 71 wt.-%, more preferably from 30 to 67 wt.-%, even more preferably from 35 to 63 wt.-%, of the at least one post-consumer recyclate polyolefin based material (PCR-PO1),
b) optionally 10 to 50 wt.-%, preferably from 13 to 45 wt.-%, more preferably from 10 to 40 wt.-%, more preferably from 15 to 30 wt.-%, of the at least one further, different post-consumer recyclate polyolefin based material (PCR-PO2),
c) 25 to 55 wt.-%, preferably from 26 to 51 wt.-%, more preferably from 28 to 50 wt.-%, even more preferably from 29 to 48 wt.-%, of the carbon black containing polyolefin (CB PO),
d) 1 to 30 wt.-%, preferably from 3 to 25 wt.-%, more preferably from 5 to 20 wt.-%, even more preferably from 8 to 15 wt.-%, of the at least one C2C4, C2C6, or C2C8 copolymer,
each based on the total weight of the polyolefin composition.

In another preferred embodiment the present invention provides said polyolefin composition, wherein the components are blended in the following amounts:
a) 10 to 50 wt.-%, preferably from 13 to 45 wt.-%, more preferably from 15 to 40 wt.-%, even more preferably from 20 to 35 wt.-%, of the at least one post-consumer recyclate polyolefin based material (PCR-PO1),
b) 10 to 50 wt.-%, preferably from 13 to 45 wt.-%, more preferably from 15 to 40 wt.-%, even more preferably from 20 to 35 wt.-%, of the at least one further, different post-consumer recyclate polyolefin based material (PCR-PO2),
c) 25 to 55 wt.-%, preferably from 26 to 51 wt.-%, more preferably from 28 to 50 wt.-%, even more preferably from 29 to 48 wt.-%, of the carbon black containing polyolefin (CB PO),
d) 1 to 30 wt.-%, preferably from 3 to 25 wt.-%, more preferably from 5 to 20 wt.-%, even more preferably from 8 to 15 wt.-%, of the at least one C2C4, C2C6, or C2C8 copolymer,
each based on the total weight of the polyolefin composition.

In another preferred embodiment the present invention provides said polyolefin composition, wherein the components are blended in the following amounts:
a) 10 to 50 wt.-%, preferably from 13 to 45 wt.-%, more preferably from 15 to 40 wt.-%, even more preferably from 20 to 35 wt.-%, of the at least one post-consumer recyclate polyolefin based material (PCR-PO1),
b) optionally 10 to 50 wt.-%, preferably from 13 to 45 wt.-%, more preferably from 15 to 40 wt.-%, even more preferably from 20 to 35 wt.-%, of the at least one further, different post-consumer recyclate polyolefin based material (PCR-PO2),
c) 25 to 55 wt.-%, preferably from 30 to 54 wt.-%, more preferably from 35 to 53 wt.-%, even more preferably from 40 to 52 wt.-%, of the carbon black containing polyolefin (CB PO),
d) 1 to 20 wt.-%, preferably from 1 to 15 wt.-%, more preferably from 2 to 10 wt.-%, even more preferably from 3 to 8 wt.-%, of the at least one C2C4, C2C6, or C2C8 copolymer,
each based on the total weight of the polyolefin composition.

In one embodiment, the at least one post-consumer recyclate polyolefin based material (PCR-PO1) preferably comprises a total amount of ethylene units (C2 units) of from 65.0 wt.-% to 99.0 wt.-%, more preferably of from 68.0 wt.-% to 96.0 wt.-%, still more preferably of from 70.0 wt.-% to 92.0 wt.-% and most preferably of from 72.0 wt.-% to 90.0 wt.-%, based on the total weight of the PCR-PO1. According to the present invention, these materials may be referred to as post-consumer recyclate polyethylene based material (PCR-PE). In this connection, it is preferred when the ethylene units (C2 units) are determined according to CRYSTEX QC method ISO 6427 Annex B. Without being bound to any theory, it is assumed that when the C2 units of a PCR-PO material are determined according to CRYSTEX QC method ISO 6427 Annex B that the vast majority of the remaining polyolefin units may be attributed to propylene units (C3 units).

In another embodiment, the at least one post-consumer recyclate polyolefin based material (PCR-PO1) preferably comprises a total amount of propylene units (C3 units) of from 80.0 wt.-% to 99.0 wt.-%, more preferably of from 85.0 wt.-% to 95.0 wt.-%, still more preferably of from 87.0 wt.-% to 93.0 wt.-% and most preferably of from 88.0 wt.-% to 92.0 wt.-%, based on the total weight of the PCR-PO1. According to the present invention, these materials may be referred to as post-consumer recyclate polypropylene based material (PCR-PP).

In yet another embodiment, the at least one post-consumer recyclate polyolefin based material (PCR-PO1) preferably comprises a total amount of propylene units (C3 units) of from 20.0 wt.-% to 80.0 wt.-%, more preferably of from 30.0 wt.-% to 75.0 wt.-%, still more preferably of from 40.0 wt.-% to 70.0 wt.-% and most preferably of from 49.0 wt.-% to 60.0 wt.-% and a total amount of ethylene units (C2 units) of from 20.0 wt.-% to 80.0 wt.-%, more preferably of from 25.0 wt.-% to 70.0 wt.-%, still more preferably of from 30.0 wt.-% to 60.0 wt.-% and most preferably of from 40.0 wt.-% to 51.0 wt.-%, each based on the total weight of the PCR-PO1. According to the present invention, these materials may be referred to as a blend of post-consumer recyclate polyethylene based material (PCR-PE) and post-consumer recyclate polypropylene based material (PCR-PP), i.e. a PCR-PP/PCR-PE blend.

Preferably, the at least one post-consumer recyclate polyolefin based material (PCR-PO1) has a melt flow rate (ISO 1133, 2.16 kg, 230° C.) of 2 to 45 g/10 min, more preferably of 3 to 40 g/10 min, still more preferably of 4 to 38 g/10 min. In a particular preferred embodiment, the at least one post-consumer recyclate polyolefin based material (PCR-PO1) has a melt flow rate (ISO 1133, 2.16 kg, 230° C.) of 10 to 45 g/10 min, more preferably of 11 to 40 g/10 min, still more preferably of 12 to 38 g/10 min. In another particular preferred embodiment, the at least one post-consumer recyclate polyolefin based material (PCR-PO1) has a melt flow rate (ISO 1133, 2.16 kg, 230° C.) of 1 to 20 g/10 min, more preferably of 2 to 13 g/10 min, still more preferably of 4 to 10 g/10 min.

Preferably, the at least one post-consumer recyclate polyolefin based material (PCR-PO1) has a density (determined according to DIN EN ISO 1183) of 900 to 956 kg/m³, more preferably of 905 to 950 kg/m³, still more preferably of 908 to 948 kg/m³, and in particular of 910 to 945 kg/m³. In another preferred embodiment, the at least one post-consumer recyclate polyolefin based material (PCR-PO1) has a density (determined according to DIN EN ISO 1183) of 900 to 945 kg/m³, more preferably of 905 to 935 kg/m³, still more preferably of 908 to 930 kg/m³, and in particular of 910 to 925 kg/m³. In another preferred embodiment, the at least one post-consumer recyclate polyolefin based material (PCR-PO1) has a density (determined according to DIN EN ISO 1183) of 915 to 956 kg/m³, more preferably of 920 to 955 kg/m³, still more preferably of 925 to 950 kg/m³, and in particular of 930 to 945 kg/m³.

Preferably, the at least one post-consumer recyclate polyolefin based material (PCR-PO1) has a tensile modulus (determined according to DIN EN ISO 527, 1 mm/min) of more than 600 MPa, more preferably more than 700 MPa, still more preferably more than 800 MPa, and in particular more than 1000 MPa. In another preferred embodiment, the at least one post-consumer recyclate polyolefin based material (PCR-PO1) has a tensile modulus (determined according to DIN EN ISO 527, 1 mm/min) in the range of 600 to 2000 MPa, preferably of 700 to 1500 MPa, still more preferably of 800 to 1200 MPa.

Preferably, the at least one post-consumer recyclate polyolefin based material (PCR-PO1) has a yield stress (determined according to DIN EN ISO 527, 50 mm/min) of more than 10 MPa, more preferably more than 15 MPa, still more preferably more than 20 MPa, and in particular more than 22 MPa. In another preferred embodiment, the at least one post-consumer recyclate polyolefin based material (PCR-PO1) has a yield stress (determined according to DIN EN ISO 527, 50 mm/min) in the range of 10 to 50 MPa, preferably of 12 to 40 MPa, still more preferably of 15 to 30 MPas.

Preferably, the at least one post-consumer recyclate polyolefin based material (PCR-PO1) has a soluble fraction (SF, determined according to CRYSTEX QC method ISO 6427 Annex B), present in an amount in the range from 5.0 to 40.0 wt.-%, more preferably from 6.0 to 30.0 wt.-%, even more preferably from 7.0 to 20.0 wt.-%, and in particular from 8.0 to 15.0 wt.-%, relative to the total weight of the PCR-PO1.

Preferably, the at least one post-consumer recyclate polyolefin based material (PCR-PO1) has a crystalline fraction (CF, determined according to CRYSTEX QC method ISO 6427 Annex B), present in an amount in the range from 60.0 to 95.0 wt.-%, more preferably from 70.0 to 94.0 wt.-%, even more preferably from 80.0 to 93.0 wt.-%, and in particular from 85.0 to 92.0 wt.-%, relative to the total weight of the total weight of the PCR-PO1.

Preferably, the at least one post-consumer recyclate polyolefin based material (PCR-PO1) has an ethylene content of the soluble fraction (measured by Fourier Transform Infrared Spectroscopy (FTIR) during CRYSTEX analysis), in the range of 15.0 to 90.0 wt.-%, more preferably from 20.0 to 60.0 wt.-%, even more preferably from 25.0 to 52.0 wt.-%, and in particular from 26.0 to 35.0 wt.-% or from 41.0 to 50.0 wt.-%.

Preferably, the at least one post-consumer recyclate polyolefin based material (PCR-PO1) has an ethylene content of the crystalline fraction (measured by Fourier Transform Infrared Spectroscopy (FTIR) during CRYSTEX analysis), in the range of 1.0 to 50.0 wt.-%, more preferably from 3.0 to 40.0 wt.-%, even more preferably from 5.0 to 30.0 wt.-%, and in particular from 6.0 to 15.0 wt.-%. In another preferred embodiment, the at least one post-consumer recyclate polyolefin based material (PCR-PO1) has an ethylene content of the crystalline fraction (measured by Fourier Transform Infrared Spectroscopy (FTIR) during CRYSTEX analysis), in the range of from 10.0 to 90.0 wt.-%, more preferably from 20.0 to 60.0 wt.-%, even more preferably from 30.0 to 55.0 wt.-%, and in particular from 40.0 to 50.0 wt.-%.

Preferably, the at least one post-consumer recyclate polyolefin based material (PCR-PO1) has an intrinsic viscosity of the soluble fraction (measured according to ISO 1628-1 at 135° C. in decalin), in the range from 0.1 to 5.0 dl/g, more preferably from 0.5 to 4.0 dl/g, even more preferably from 0.6 to 3.0 dl/g, and in particular from 1.0 to 2.5 dl/g.

Preferably, the at least one post-consumer recyclate polyolefin based material (PCR-PO1) has an intrinsic viscosity of the crystalline fraction (measured according to ISO 1628-1 at 135° C. in decalin), in the range from 0.1 to 5.0 dl/g, more preferably from 0.5 to 4.0 dl/g, even more preferably from 0.6 to 3.0 dl/g, and in particular from 1.0 to 2.2 dl/g.

Preferably, the at least one post-consumer recyclate polyolefin based material (PCR-PO1) has a ratio of the intrinsic viscosity of the soluble fraction (measured according to ISO 1628-1 at 135° C. in decalin) versus the intrinsic viscosity of the crystalline fraction (measured according to ISO 1628-1 at 135° C. in decalin) IV(SF)/IV(CF) in the range of 0.2 to 3.0, more preferably of 0.3 to 2.5, even more preferably of 0.5 to 1.6, and in particular of 0.6 to 1.0 or of more than 1.0 to 1.5.

Due to the differences in the separation methods using extraction by xylene and by 1,2,4-trichlorobenzene, the properties of XCS/XCI fractions on the one hand and soluble/crystalline (SF/CF) fractions on the other hand are not exactly the same, but are similar. More details are given in the experimental part.

Preferably, the at least one post-consumer recyclate polyolefin based material (PCR-PO1) has a polydispersity index PI of from 1.5 to 5.0 Pa⁻¹, more preferably from 2.2 to 4.2 Pa⁻¹, and in particular from 2.6 to 3.8 Pa⁻¹.

Preferably, the at least one post-consumer recyclate polyolefin based material (PCR-PO1) has a complex viscosity at the frequency of 300 rad/s, eta300, of from 100 to 450 Pa·s, more preferably from 150 to 400 Pa·s, and in particular from 200 to 350 Pa·s.

Preferably, the at least one post-consumer recyclate polyolefin based material (PCR-PO1) has a complex viscosity at the frequency of 0.05 rad/s, eta0.05, of from 800 to 8000 Pa·s, more preferably from 1000 to 7000 Pa·s, even more preferably from 1100 to 6000 Pa·s, and in particular from 1300 to 2000 Pa·s. In another preferred embodiment, the at least one post-consumer recyclate polyolefin based material (PCR-PO1) has a complex viscosity at the frequency of 0.05 rad/s, eta0.05, of from 800 to 6000 Pa·s, more preferably from 900 to 5000 Pa·s, even more preferably from 1000 to 4500 Pa·s, and in particular from 1200 to 4000 Pa·s. In another preferred embodiment, the at least one post-consumer recyclate polyolefin based material (PCR-PO1) has a complex viscosity at the frequency of 0.05 rad/s, eta0.05, of from 2000 to 10000 Pa·s, more preferably from 3000 to 9000 Pa·s, even more preferably from 4000 to 8000 Pa·s, and in particular from 5000 to 8000 Pa·s.

Preferably, the at least one post-consumer recyclate polyolefin based material (PCR-PO1) has a crystallization temperature (determined according to ISO 11357/part 3/10K/min) of 110 to 140° C., more preferably of 115 to 135° C., even more preferably of 118 to 130° C., and in particular of 120 to 126° C.

Preferably, the at least one post-consumer recyclate polyolefin based material (PCR-PO1) comprises less than 10 wt.-%, preferably less than 5 wt.-%, and in particular less than 2 wt.-%, of a metal (determined by x ray fluorescence (XRF)), based on the total weight of the at least one post-consumer recyclate polyolefin based material (PCR-PO1).

In one embodiment, the at least one further, different post-consumer recyclate polyolefin based material (PCR-PO2) preferably comprises a total amount of ethylene units (C2 units) of from 65.0 wt.-% to 99.0 wt.-%, more preferably of from 68.0 wt.-% to 96.0 wt.-%, still more preferably of from 70.0 wt.-% to 92.0 wt.-% and most preferably of from 72.0 wt.-% to 90.0 wt.-%, based on the total weight of the PCR-PO2.

In another embodiment, the at least one further, different post-consumer recyclate polyolefin based material (PCR-PO2) preferably comprises a total amount of propylene units (C3 units) of from 80.0 wt.-% to 99.0 wt.-%, more preferably of from 85.0 wt.-% to 95.0 wt.-%, still more preferably of from 87.0 wt.-% to 93.0 wt.-% and most preferably of from 88.0 wt.-% to 92.0 wt.-%, based on the total weight of the PCR-PO2.

In yet another embodiment, the at least one further, different post-consumer recyclate polyolefin based material (PCR-PO2) preferably comprises a total amount of propylene units (C3 units) of from 20.0 wt.-% to 80.0 wt.-%, more preferably of from 30.0 wt.-% to 75.0 wt.-%, still more preferably of from 40.0 wt.-% to 70.0 wt.-% and most preferably of from 49.0 wt.-% to 60.0 wt.-% and a total amount of ethylene units (C2 units) of from 20.0 wt.-% to 80.0 wt.-%, more preferably of from 25.0 wt.-% to 70.0 wt.-%, still more preferably of from 30.0 wt.-% to 60.0 wt.-% and most preferably of from 40.0 wt.-% to 51.0 wt.-%, each based on the total weight of the PCR-PO2. Preferably, the ethylene units (C2 units) are determined according to CRYSTEX QC method ISO 6427 Annex B.

Preferably, the at least one further, different post-consumer recyclate polyolefin based material (PCR-PO2) has a melt flow rate (ISO 1133, 2.16 kg, 230° C.) of 2 to 45 g/10 min, more preferably of 3 to 40 g/10 min, still more preferably of 4 to 38 g/10 min. In a particular preferred embodiment, the at least one further, different post-consumer recyclate polyolefin based material (PCR-PO2) has a melt flow rate (ISO 1133, 2.16 kg, 230° C.) of 1 to 10 g/10 min, more preferably of 2 to 8 g/10 min, still more preferably of 3 to 7 g/10 min.

Preferably, the at least one further, different post-consumer recyclate polyolefin based material (PCR-PO2) has a density (determined according to DIN EN ISO 1183) of 900 to 956 kg/m³, more preferably of 905 to 950 kg/m³, still more preferably of 908 to 948 kg/m³, and in particular of 910 to 945 kg/m³. In another preferred embodiment, the at least one further, different post-consumer recyclate polyolefin based material (PCR-PO2) has a density (determined according to DIN EN ISO 1183) of 900 to 970 kg/m³, more preferably of 920 to 960 kg/m³, still more preferably of 925 to 955 kg/m³, and in particular of 930 to 950 kg/m³.

Preferably, the at least one further, different post-consumer recyclate polyolefin based material (PCR-PO2) has a tensile modulus (determined according to DIN EN ISO 527, 1 mm/min) of more than 600 MPa, more preferably more than 700 MPa, still more preferably more than 800 MPa.

Preferably, the at least one further, different post-consumer recyclate polyolefin based material (PCR-PO2) has a yield stress (determined according to DIN EN ISO 527, 50 mm/min) of more than 10 MPa, more preferably more than 15 MPa, still more preferably more than 20 MPa.

Preferably, the at least one further, different post-consumer recyclate polyolefin based material (PCR-PO2) has a soluble fraction (SF, determined according to CRYSTEX QC method ISO 6427 Annex B), present in an amount in the range from 5.0 to 40.0 wt.-%, more preferably from 6.0 to 30.0 wt.-%, even more preferably from 7.0 to 20.0 wt.-%, and in particular from 8.0 to 15.0 wt.-%, relative to the total weight of the PCR-PO2.

Preferably, the at least one further, different post-consumer recyclate polyolefin based material (PCR-PO2) has a crystalline fraction (CF, determined according to CRYSTEX QC method ISO 6427 Annex B), present in an amount in the range from 60.0 to 95.0 wt.-%, more preferably from 70.0 to 94.0 wt.-%, even more preferably from 80.0 to 93.0 wt.-%, and in particular from 85.0 to 92.0 wt.-%, relative to the total weight of the total weight of the PCR-PO2.

Preferably, the at least one further, different post-consumer recyclate polyolefin based material (PCR-PO2) has an ethylene content of the soluble fraction (measured by Fourier Transform Infrared Spectroscopy (FTIR) during CRYSTEX analysis), in the range of 15.0 to 70.0 wt.-%, more preferably from 20.0 to 60.0 wt.-%, even more preferably from 25.0 to 52.0 wt.-%, and in particular from 26.0 to 35.0 wt.-% or from 41.0 to 50.0 wt.-%.

Preferably, the at least one further, different post-consumer recyclate polyolefin based material (PCR-PO2) has an ethylene content of the crystalline fraction (measured by Fourier Transform Infrared Spectroscopy (FTIR) during CRYSTEX analysis), in the range of 10.0 to 90.0 wt.-%, more preferably from 20.0 to 60.0 wt.-%, even more preferably from 30.0 to 55.0 wt.-%, and in particular from 40.0 to 50.0 wt.-%.

Preferably, the at least one further, different post-consumer recyclate polyolefin based material (PCR-PO2) has an intrinsic viscosity of the soluble fraction (measured according to ISO 1628-1 at 135° C. in decalin), in the range from 0.1 to 5.0 dl/g, more preferably from 0.5 to 4.0 dl/g, even more preferably from 0.6 to 3.0 dl/g, and in particular from 1.0 to 2.5 dl/g.

Preferably, the at least one further, different post-consumer recyclate polyolefin based material (PCR-PO2) has an intrinsic viscosity of the crystalline fraction (measured according to ISO 1628-1 at 135° C. in decalin), in the range from 0.1 to 5.0 dl/g, more preferably from 0.5 to 4.0 dl/g, even more preferably from 0.6 to 3.0 dl/g, and in particular from 1.0 to 2.2 dl/g.

Preferably, the at least one further, different post-consumer recyclate polyolefin based material (PCR-PO2) has a ratio of the intrinsic viscosity of the soluble fraction (measured according to ISO 1628-1 at 135° C. in decalin) versus the intrinsic viscosity of the crystalline fraction (measured according to ISO 1628-1 at 135° C. in decalin) IV(SF)/IV(CF) in the range of 0.2 to 3.0, more preferably of 0.3 to 2.5, even more preferably of 0.5 to 1.6, and in particular of 0.6 to 1.0 or of more than 1.0 to 1.5.

Preferably, the at least one further, different post-consumer recyclate polyolefin based material (PCR-PO2) has a polydispersity index PI of from 1.5 to 5.0 Pa⁻¹, more preferably from 2.2 to 4.2 Pa⁻¹, and in particular from 2.6 to 3.8 Pa⁻¹.

Preferably, the at least one further, different post-consumer recyclate polyolefin based material (PCR-PO2) has a complex viscosity at the frequency of 300 rad/s, eta300, of from 100 to 450 Pa·s, more preferably from 150 to 400 Pa·s, and in particular from 200 to 350 Pa·s.

Preferably, the at least one further, different post-consumer recyclate polyolefin based material (PCR-PO2) has a complex viscosity at the frequency of 0.05 rad/s, eta0.05, of from 800 to 8000 Pa·s, more preferably from 1000 to 7000 Pa·s, even more preferably from 1100 to 6000 Pa·s, and in particular from 1300 to 2000 Pa·s. In another preferred embodiment, the at least one further, different post-consumer recyclate polyolefin based material (PCR-PO2) has a complex viscosity at the frequency of 0.05 rad/s, eta0.05, of from 2000 to 9000 Pa·s, more preferably from 3000 to 8000 Pa·s, even more preferably from 4000 to 7000 Pa·s, and in particular from 5000 to 6000 Pa·s.

Preferably, the at least one further, different post-consumer recyclate polyolefin based material (PCR-PO2) has a crystallization temperature (determined according to ISO 11357/part 3/10K/min) of 110 to 140° C., more preferably of 115 to 135° C., even more preferably of 118 to 130° C., and in particular of 120 to 126° C.

Preferably, the at least one further, different post-consumer recyclate polyolefin based material (PCR-PO2) comprises less than 10 wt.-%, preferably less than 5 wt.-%, and in particular less than 2 wt.-%, of a metal (determined by x ray fluorescence (XRF)), based on the total weight of the at least further, different post-consumer recyclate polyolefin based material (PCR-PO2).

It is to be understood that if the at least one further, different post-consumer recyclate polyolefin based material (PCR-PO2) is applied it differs from the at least one post-consumer recyclate polyolefin based material (PCR-PO1) preferably at least in the melt flow rate (determined according to DIN EN ISO 1133, 230° C./2.16 kg). Preferably, the melt flow rate (determined according to DIN EN ISO 1133, 230° C./2.16 kg) of PCR-PO2 differs from the melt flow rate (determined according to DIN EN ISO 1133, 230° C./2.16 kg) of PCR-PO1 in a value of at least 2 g/10 min, more preferably at least 5 g/10 min, still more preferably at least 10 g/10 min, and in particular at least 15 g/10 min.

Further, the at least one further, different post-consumer recyclate polyolefin based material (PCR-PO2) may differ in particular in the total amount of the ethylene units, the total amount of the propylene units, and/or the density (determined according to DIN EN ISO 1183). Preferably, the at least one further, different post-consumer recyclate polyolefin based material (PCR-PO2) differs from the at least one post-consumer recyclate polyolefin based material (PCR-PO1) in the total amount of the ethylene units and/or the total amount of the propylene units. Preferably, the at least one post-consumer recyclate polyolefin based material (PCR-PO1) comprises a total amount of propylene units (C3 units) of 80.0 to 99.0 wt.-%, based on the total weight of the PCR-PO1 and the at least one further, different post-consumer recyclate polyolefin based material (PCR-PO2) comprises a total amount of propylene units (C3 units) of 1.0 to 75.5 wt.-% or less, based on the total weight of the PCR-PO2.

Preferably, the at least one post-consumer recyclate polyolefin based material (PCR-PO1) comprises a total amount of ethylene units (C2 units) of 2.0 to 30.0 wt.-%, more preferably of 5.0 to 25.0 wt.-%, based on the total weight of the PCR-PO1 and the at least one further, different post-consumer recyclate polyolefin based material (PCR-PO2) comprises a total amount of ethylene units (C2 units) of more than 30.0 wt.-% to 60.0 wt.-%, more preferably of 40.0 wt.-% to 51.0 wt.-%, based on the total weight of the PCR-PO2.

Preferably, the at least one post-consumer recyclate polyolefin based material (PCR-PO1) has a melt flow rate (ISO 1133, 2.16 kg, 230° C.) of 11 to 45 g/10 min, more preferably of 14 to 40 g/10 min, still more preferably of 20 to 38 g/10 min and the at least one further, different post-consumer recyclate polyolefin based material (PCR-PO2) has a melt flow rate (ISO 1133, 2.16 kg, 230° C.) of 2 to less than 11 g/10 min, more preferably of 3 to 9 g/10 min, still more preferably of 4 to 8 g/10 min.

Preferably, the at least one post-consumer recyclate polyolefin based material (PCR-PO1) has a density (determined according to DIN EN ISO 1183) of 900 to 930 kg/m³, more preferably of 905 to 927 kg/m³, still more preferably of 908 to 925 kg/m³, and in particular of 910 to 922 kg/m³ and the at least one further, different post-consumer recyclate polyolefin based material (PCR-PO2) has a density (determined according to DIN EN ISO 1183) of more than 930 to 956 kg/m³, more preferably of 932 to 950 kg/m³, still more preferably of 934 to 948 kg/m³, and in particular of 936 to 945 kg/m³.

In a preferred embodiment, the polyolefin composition is obtainable by blending the at least one post-consumer recyclate polyolefin based material (PCR-PO1) comprising a total amount of propylene units (C3 units) of from 80.0 wt.-% to 99.0 wt.-%, more preferably of from 85.0 wt.-% to 95.0 wt.-%, still more preferably of from 87.0 wt.-% to 93.0 wt.-% and most preferably of from 88.0 wt.-% to 92.0 wt.-%, based on the total weight of the PCR-PO1, with the at least one further, different post-consumer recyclate polyolefin based material (PCR-PO2) comprising a total amount of propylene units (C3 units) of from 20.0 wt.-% to 80.0 wt.-%, more preferably of from 30.0 wt.-% to 75.0 wt.-%, still more preferably of from 40.0 wt.-% to 70.0 wt.-% and most preferably of from 49.0 wt.-% to 60.0 wt.-% and a total amount of ethylene units (C2 units) of from 20.0 wt.-% to 80.0 wt.-%, more preferably of from 25.0 wt.-% to 70.0 wt.-%, still more preferably of from 30.0 wt.-% to 60.0 wt.-% and most preferably of from 40.0 wt.-% to 51.0 wt.-%, each based on the total weight of the PCR-PO2. In this connection, the weight ratio of PCR-PO1 to PCR-PO2 is preferably from 2:1 to 1:2, more preferably from 1.5:1 to 1:1.5.

According to one embodiment the present invention provides said polyolefin composition, wherein the at least one post-consumer recyclate polyolefin based material (PCR-PO1) is selected from the group consisting of post-consumer recyclate polypropylene based material (PCR-PP1), post-consumer recyclate polyethylene based material (PCR-PE1), and blends thereof, preferably post-consumer recyclate polypropylene based material (PCR-PP1).

In a preferred embodiment, the present invention provides said polyolefin composition, wherein the components are blended in the following amounts:
a) from 30 to 70 wt.-%, preferably from 33 to 67 wt.-%, more preferably from 35 to 64 wt.-%, of the at least one post-consumer recyclate polyolefin based material (PCR-PO1) being a post-consumer recyclate polypropylene based material (PCR-PP1) comprising a total amount of propylene units (C3 units) of from 80.0 wt.-% to 99.0 wt.-%, more preferably of from 85.0 wt.-% to 95.0 wt.-%, still more preferably of from 87.0 wt.-% to 93.0 wt.-% and most preferably of from 88.0 wt.-% to 92.0 wt.-%, based on the total weight of the PCR-PP1,
b) optionally from 10 to 40 wt.-%, preferably from 13 to 34 wt.-%, more preferably from 15 to 29 wt.-%, of the at least one further, different post-consumer recyclate polyolefin based material (PCR-PO2),
c) from 25 to 55 wt.-%, preferably from 26 to 51 wt.-%, more preferably from 28 to 48 wt.-%, of the carbon black containing polyolefin (CB PO),
d) from 5 to 20 wt.-%, preferably from 7 to 18 wt.-%, more preferably from 8 to 15 wt.-%, of the at least one C2C4, C2C6, or C2C8 copolymer,
wherein the amounts of PCR-PO1, PCR-PO2, the carbon black containing polyolefin (CB PO), and the copolymer are each based on the total weight of the polyolefin composition.

In another preferred embodiment, the present invention provides said polyolefin composition, wherein the components are blended in the following amounts:
a) from 15 to 40 wt.-%, preferably from 17 to 38 wt.-%, more preferably from 20 to 35 wt.-%, of the at least one post-consumer recyclate polyolefin based material (PCR-PO1) being a post-consumer recyclate polypropylene based material (PCR-PP1) comprising a total amount of propylene units (C3 units) of from 80.0 wt.-% to 99.0 wt.-%, more preferably of from 85.0 wt.-% to 95.0 wt.-%, still more preferably of from 87.0 wt.-% to 93.0 wt.-% and most preferably of from 88.0 wt.-% to 92.0 wt.-%, based on the total weight of the PCR-PP1,
b) from 15 to 40 wt.-%, preferably from 17 to 38 wt.-%, more preferably from 20 to 35 wt.-%, of the at least one further, different post-consumer recyclate polyolefin based material (PCR-PO2),
c) from 25 to 55 wt.-%, preferably from 26 to 51 wt.-%, more preferably from 28 to 48 wt.-%, of the carbon black containing polyolefin (CB PO),
d) from 5 to 20 wt.-%, preferably from 7 to 18 wt.-%, more preferably from 8 to 15 wt.-%, of the at least one C2C4, C2C6, or C2C8 copolymer, preferably C2C8 copolymer,
wherein the amounts of PCR-PO1, PCR-PO2, the carbon black containing polyolefin (CB PO), and the copolymer are each based on the total weight of the polyolefin composition. In this connection, the PCR-PO2 is preferably a PCR-PP/PCR-PE blend.

Preferably, the at least one post-consumer recyclate polyolefin based material (PCR-PO1), as well as the at least one further, different post-consumer recyclate polyolefin based material (PCR-PO2), have a moister content (determined via a moister infrared analyzer, 105° C.) of less than 0.1%.

In the event that the at least one further, different post-consumer recyclate polyolefin based material (PCR-PO2) is applied, it is preferred that either the PCR-PO1 or the PCR-PO2 has a density (determined according to DIN EN ISO 1183) of 910 to 925 kg/m³.

In the event that the at least one further, different post-consumer recyclate polyolefin based material (PCR-PO2) is applied, it is preferred that either the PCR-PO1 or the PCR-PO2 has a tensile modulus (determined according to DIN EN ISO 527, 1 mm/min) of more than 900 MPa, preferably more than 1000 MPa.

In a preferred embodiment, the present invention provides said polyolefin composition, wherein the carbon black containing polyolefin (CB PO) is blended in an amount from 25 to 55 wt.-%, preferably from 26 to 51 wt.-%, more preferably from 28 to 50 wt.-%, even more preferably from 29 to 48 wt.-%, based on the total weight of the polyolefin composition. In another preferred embodiment, the present invention provides said polyolefin composition, wherein the carbon black containing polyolefin (CB PO) is blended in an amount from 25 to 48 wt.-%, preferably from 28 to 45 wt.-%, more preferably from 29 to 42 wt.-%, based on the total weight of the polyolefin composition.

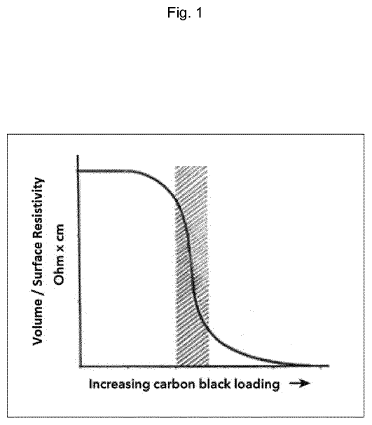

In general, adjusting an ideally balanced carbon blank amount in the polyolefin composition is needed. In the event, that the carbon black amount is too high, the mechanical properties of the polyolefin composition deteriorate. In the event, that the carbon black amount is too low, the electronic conductivity deteriorates. This is also schematically illustrated by the stiffness curve of a polymer matrix in FIG. 1. There is a sensitive area where the conductivity drops rapidly around the percolation point. Hence, an accurate control in dosing the carbon black is needed.

In this connection, the present invention further provides said polyolefin composition comprising a total of 10 to 23 wt.-%, more preferably of 11 to 21 wt.-%, still more preferably of 12 to 19 wt.-%, of carbon black, based on the total weight of the polyolefin composition. In a specific embodiment, the polyolefin composition comprises a total of 10 to 20 wt.-%, more preferably of 11 to 18 wt.-%, still more preferably of 12 to 17 wt.-%, of carbon black, based on the total weight of the polyolefin composition.

The carbon black containing polyolefin (CB PO) may comprise any known polyolefin. It is to be understood that the carbon black containing polyolefin (CB PO) comprises, preferably consists of virgin polyolefin, in particular polyolefins selected from the group consisting of polyethylene, polypropylene, and polybutene. According to the present invention, the carbon black containing polyolefin (CB PO) comprises carbon black preferably from 30 to 60 wt.-%, more preferably from 35 to 50 wt.-%, and in particular from 38 to 42 wt.-%, based on the total weight of the carbon black containing polyolefin (CB PO). The polyolefin is comprised in the carbon black containing polyolefin (CB PO) preferably from 40 to 70 wt.-%, more preferably from 50 to 65 wt.-%, and in particular from 58 to 62 wt.-%, based on the total weight of the carbon black containing polyolefin (CB PO).

In a preferred embodiment, the carbon black containing polyolefin (CB PO) comprises a carbon black containing polyethylene. It is further preferred that the carbon black containing polyolefin (CB PO) comprises at least 50 wt.-%, more preferably at least 55 wt.-%, and in particular at least 60 wt.-%, of polyethylene, based on the total weight of the carbon black containing polyolefin (CB PO). In a particular preferred embodiment, the carbon black containing polyolefin (CB PO) comprises from 30 to 60 wt.-%, preferably from 35 to 50 wt.-%, and in particular from 38 to 42 wt.-%, of carbon black and from 40 to 70 wt.-%, preferably from 50 to 65 wt.-%, and in particular from 58 to 62 wt.-%, of polyethylene, each based on the total weight of the carbon black containing polyolefin (CB PO). It is preferred that the carbon black containing polyolefin (CB PO) comprises, more preferably consists of virgin polyethylene. It is also preferred that the carbon black containing polyolefin (CB PO) comprises, more preferably consists of high density polyethylene (HDPE). This high density polyethylene is a virgin material which has not already been recycled.

Preferably, the carbon black containing polyolefin (CB PO) has a melt flow rate (MFR₂₁; determined according to ISO 1133, 21.6 kg, 190° C.) of 20 to 70 g/10 min, preferably of 30 to 60 g/10 min, more preferably of 35 to 55 g/10 min, and in particular of 40 to 50 g/10 min.

Preferably, the carbon black comprised in the at least one carbon black containing polyolefin homopolymer (CB-PO) has a pour (bulk) density, determined according to ASTM D1513, from 200 to 600 g/l, more preferably from 250 to 550 g/l, and in particular from 280 to 500 g/l.

Preferably, the carbon black comprised in the at least one carbon black containing polyolefin homopolymer (CB-PO) has a mean primary particle size, determined according to ASTM D3849, from 1 to 80 nm, preferably, from 4 to 60 nm, and in particular from 8 to 40 nm.

According to the present invention, the at least one C2C4, C2C6, or C2C8 copolymer is preferably obtained by polymerization of ethylene with an alpha-olefin having 4, 6, or 8 carbon atoms.

In a preferred embodiment of the present invention, the at least one C2C4, C2C6, or C2C8 copolymer is obtained by polymerization of ethylene with an alpha-olefin having 4, 6, or 8 carbon atoms selected from the group consisting of 1-butene, 1-hexene, and 1-octene. Applying a C2C8 copolymer is preferred.

In a preferred embodiment of the present invention, the C2C8 copolymer comprises ethylene units (C2 units) and 1-octene units (C8 units) and is preferably produced in a solution polymerisation process using a metallocene catalyst. When the C2C8 copolymer comprises ethylene units and 1-octene units it may be referred to a “C2C8 plastomer”. Likewise, a C2C6 copolymer comprising ethylene units and 1-hexene units may be referred to a “C2C6 plastomer”. The term “plastomer” denotes a polymer combining qualities of elastomers and plastics. The term “C2C8 plastomer” denotes a polymer combining qualities of elastomers and plastics whereby the polymer's structural units are derived from monomers consisting of ethylene and 1-octene.

The at least one C2C4, C2C6, or C2C8 copolymer has a density (determined according to DIN EN ISO 1183) of 860-890 kg/m³, preferably of 865 to 880 kg/m³, and in particular of 865 to 875 kg/m³.

The at least one C2C4, C2C6, or C2C8 copolymer has a melt flow rate (ISO 1133, 2.16 kg, 190° C.) of 0.3 to 35.0 g/10 min, preferably of 0.4 to 30 g/10 min, more preferably of 0.5 to 20 g/10 min, and in particular of 4 to 15 g/10 min.

Preferably, the at least one C2C4, C2C6, or C2C8 copolymer has a melting temperature (DSC, determined according to ISO 11357-3) of 35 to 85° C., preferably of 42 to 80° C., and in particular of 44 to 55° C.

Preferably, the at least one C2C4, C2C6, or C2C8 copolymer has a Vicat softening temperature (10N, determined according to ISO 306) of 27 to 50° C., more preferably of 28 to 45° C., even more preferably of 29 to 40° C., and in particular of 30 to 37° C.

In a preferred embodiment, the present invention further provides said polyolefin composition, obtainable by blending with additionally
e) 1 to 25 wt.-%, preferably 4 to 20 wt.-%, and in particular 5 to 17 wt.-%, based on the total weight of the polyolefin composition, of a polyolefin material. In another preferred embodiment, the present invention further provides said polyolefin composition, obtainable by blending with additionally
e) 5 to 27 wt.-%, preferably 10 to 25 wt.-%, and in particular 15 to 23 wt.-%, based on the total weight of the polyolefin composition, of a polyolefin material.

The polyolefin material is a virgin polyolefin, preferably a polyolefin homopolymer material. Further, the polyolefin material is preferably a polyethylene material, a polypropylene material, or blends thereof. Preferably, the polyolefin material has a melt flow rate (ISO 1133, 2.16 kg, 190° C.) of 800 to 1600 g/10 min, more preferably of 900 to 1500 g/10 min, and in particular of 1000 to 1300 g/10 min. Preferably, the polyolefin material has a melting temperature (DSC, determined according to ISO 11357-3) of 145 to 170° C., more preferably of 150 to 168° C., and in particular of 154 to 164° C. Preferably, the polyolefin material is a polyolefin melt-blown material, more preferably a polypropylene melt-blown material, and in particular a polypropylene homopolymer melt-blown material.

The present invention is further directed to said polyolefin composition comprising preferably less than 10 wt.-%, more preferably less than 5 wt.-%, and in particular less than 2 wt.-%, of aluminum (determined by x ray fluorescence (XRF)), based on the total weight of the polyolefin composition. In this connection it is preferred that the at least one post-consumer recyclate polyolefin based material (PCR-PO1), as well as the optional at least one further, different post-consumer recyclate polyolefin based material (PCR-PO2), comprise less than 20 wt.-%, preferably less than 15 wt.-%, more preferably less than 10 wt.-%, of aluminum, and in particular less than 5 wt.-%, (determined by x ray fluorescence (XRF)), based on the total weight of the at least one PCR-PO1 (or based on the at least one further, different PCR-PO2, respectively).

The polyolefin composition has a melt flow rate (ISO 1133, 2.16 kg, 230° C.) of 7 to 20 g/10 min, preferably of 7 to 15 g/10 min or of 8 to 15 g/10 min.

Preferably, the polyolefin composition has a tensile modulus (determined according to DIN EN ISO 527, 1 mm/min) of at least 800 MPa, more preferably at least 900 MPa, and in particular at least 1000 MPa. The polyolefin composition preferably has a tensile modulus (determined according to DIN EN ISO 527, 1 mm/min) of 800 to 1700 MPa, more preferably of 900 to 1400 MPa, and in particular of 1000 to 1300 MPa. Tensile tests are preferably carried out after at least 96 hours of conditioning at 23° C.

The polyolefin composition has a Volume Resistivity (determined according to ISO 3915 at a temperature of 23° C. and 50% relative humidity) from 5 to 1400 Ohm·cm, preferably from 10 to 800 Ohm·cm, more preferably from 15 to 400 Ohm·cm, even more preferably from 17 to 300 Ohm·cm, and in particular from 20 to 250 Ohm·cm.

The polyolefin composition has preferably a Charpy NIS (determined according to ISO 179/1 eA at 23° C.) of 4 to 55 kJ/m², more preferably of 5 to 50 kJ/m², still more preferably of 8 to 45 kJ/m², and in particular of 15 to 40 kJ/m². Charpy tests are preferably carried out after at least 96 hours of conditioning at 23° C.

In a further aspect, the present invention is directed to electroconductive boxes, crates, or pellets comprising the above further defined polyolefin composition.

In yet another aspect, the present invention is directed to electroconductive boxes, crates, or pellets comprising a polyolefin composition, which is produced from at least one post-consumer recyclate polyolefin based material (PCR-PO1) and more than 20 wt.-% of a carbon black containing polyolefin (CB PO), based on the total weight of the polyolefin composition. Preferably, the polyolefin composition comprises a total of 10 to 23 wt.-%, more preferably of 11 to 21 wt.-%, still more preferably of 12 to 19 wt.-%, of carbon black, based on the total weight of the polyolefin composition. In this connection, the article is preferably produced via injection-moulding. In a specific embodiment, the polyolefin composition comprises a total of 10 to 20 wt.-%, more preferably of 11 to 18 wt.-%, still more preferably of 12 to 17 wt.-%, of carbon black, based on the total weight of the polyolefin composition. In this connection, the article is preferably produced via compression-moulding.

All preferred aspects, definitions and embodiments as described above shall also hold for the electroconductive boxes, crates, or pellets.

In yet another aspect, the present invention is directed to the use of post-consumer recyclate polyolefin based material having an aluminum content of less than 10 wt.-%, preferably less than 5 wt.-%, and in particular less than 2 wt.-% (determined by x ray fluorescence (XRF)), based on the total weight of the post-consumer recyclate polyolefin based material, for producing electroconductive boxes, crates, or pellets. It is preferred if the post-consumer recyclate polyolefin based material is blended with a carbon black containing polyolefin (CB PO) and at least one C2C4, C2C6, or C2C8 copolymer so that the impact/stiffness/electric conductivity balance of the polyolefin composition is improved.

All preferred aspects, definitions and embodiments as described above shall also hold for the use.

The gist of the present invention will be further outlined in the following examples.

### EXPERIMENTAL PART

### 1. Test Methods

### a) Melt Flow Rate

Melt flow rates were measured with a load of 2.16 kg (MFR₂) at 230° C. or 190° C. as indicated. The melt flow rate is that quantity of polymer in grams which the test apparatus standardized to ISO 1133 extrudes within 10 minutes at a temperature of 230° C. or 190° C. under a load of 2.16 kg. For assessing MFR₂₁, 21.6 kg load was used.

MFR₂ (230° C.) is measured according to ISO 1133 (230° C., 2.16 kg load).

MFR₂ (190° C.) is measured according to ISO 1133 (190° C., 2.16 kg load).

MFR₂₁ (190° C.) is measured according to ISO 1133 (190° C., 21.6 kg load).

### b) Volume Resistivity, Ohm·cm

The Volume Resistivity is measured based on the ISO 3915. A 4-point multimeter with crocodile clips is used and the measurement is carried out in a room with a temperature of 23° C. and 50% relative humidity. Specimens for electrical measurement are prepared via compression-moulding with a dimension of 160×25×3 mm.

### c) Tensile Modulus [MPa]

The Tensile Modulus is measured according to ISO 527-2 (cross head speed=50 mm/min; 23° C., unless identified differently) using injection molded specimens as described in EN ISO 1873-2 (dog bone shape, 4 mm thickness). Tensile tests were carried out after at least 96 hours of conditioning at 23° C.

### d) Charpy Notched Impact Strength (NIS)

The impact strength is determined according to ISO 179/1 eA at 23° C. by using injection moulded test specimens as described in EN ISO 1873-2 (80×10×4 mm). Charpy tests were carried out after at least 96 hours of conditioning at 23° C.

### e) DSC Analysis, Melting Temperature (Tm) and Heat of Fusion (Hf), Crystallization Temperature (Tc) and Melt Enthalpy (Hm)

The DSC is measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. The crystallization temperature (Tc) is determined from the cooling step, while melting temperature (Tm) and melting enthalpy (Hm) are determined from the second heating step. The crystallinity is calculated from the melting enthalpy by assuming an Hm-value of 209 J/g for a fully crystalline polypropylene (see Brandrup, J., Immergut, E. H., Eds. Polymer Handbook, 3rd ed. Wiley, New York, 1989; Chapter 3).

### f) Density

Density is measured according to ISO 1183-187. Sample preparation is done by compression moulding in accordance with ISO 17855-2.

### g) Yield Stress

Tensile properties were determined on samples prepared from compression-moulded plaques having a sample thickness of 4 mm. Tensile modulus was determined according to ISO 527-2/1 B at 1 mm/min. and 23° C. To determine stress at yield and strain at yield, a speed of 50 mm/min. was used.

### h) Vicat Softening Temperature

The Vicat softening temperature is used in measuring technology for the melting point. It indicates the temperature at which a circular indenter with a cross-section of 1 mm 2 under a standard load of 10 N or 50 N will penetrate the specimen precisely 1 mm deep. The Vicat softening temperature is defined in ISO 306. Unless otherwise indicated according to the present application a standard load of 10N is applied.

i) Crystalline and Soluble Fractions and their Respective Properties (Crystex Analysis)

The crystalline (CF) and soluble fractions (SF) of the polyolefin (PO) compositions, the final ethylene units content of the PO composition, the ethylene units content of the respective fractions, as well as the intrinsic viscosities of the respective fractions were analysed by the CRYSTEX QC Polymer Char (Valencia, Spain) on basis ISO 6427 Annex B: 1992 (E). A schematic representation of the CRYSTEX QC instrument is presented in Del Hierro, P.; Ortin, A.; Monrabal, B.; ‘Soluble Fraction Analysis in polypropylene, The Column, February 2014. Pages 18-23. The crystalline and amorphous fractions are separated through temperature cycles of dissolution in 1,2,4-trichlorobenzene (1,2,4-TCB) at 160° C., crystallization at 40° C. and re-dissolution in 1,2,4-TCB at 160° C. Quantification of SF and CF and determination of ethylene content (C2) are achieved by means of an infrared detector (IR4) and an online 2-capillary viscometer is used for the determination of the intrinsic viscosity (IV).

IR4 detector is a multiple wavelength detector detecting IR absorbance at two different bands (CH₃ stretching vibration (centred at approx. 2960 cm⁻¹) and CHₓ stretching vibration (2700-3000 cm⁻¹)) which can be used to determine of the concentration and the ethylene content in ethylene-propylene copolymers (EP copolymers). The IR4 detector is calibrated with series of 8 EP copolymers with known ethylene content in the range of 2 wt.-% to 69 wt.-% (determined by 13C-NMR) and each at various concentrations, in the range of 2 and 13 mg/ml. To account for both features, concentration and ethylene content at the same time for various polymer concentration expected during Crystex analyses the following calibration equations were applied:

Conc=a+b*Abs(CH)+c*(Abs(CHₓ))²+d*Abs(CH₃)+e*(Abs(CH₃))²+f*Abs(CHₓ)*Abs(CH₃) Equation 1:

CH₃/1000C=a+b*Abs(CHₓ)+c*Abs(CH₃)+d*(Abs(CH₃)/Abs(CHₓ))+e*(Abs(CH₃)/Abs(CHₓ))² Equation 2:

The constants a to e for equation 1 and a to f for equation 2 were determined by using least square regression analysis.

The CH3/1000C is converted to the ethylene content in wt.-% using following relationship:

wt.-% (Ethylene in EP Copolymers)=100−CH₃/1000TC*0.3 Equation 3:

Amount of Soluble fraction (SF) and Crystalline Fraction (CF) are correlated through the XS calibration to the “Xylene Cold Soluble” (XCS) fraction and “Xylene Cold Insoluble” (XCI) fraction, respectively, determined according to standard gravimetric method as per ISO16152. XS calibration is achieved by testing various EP copolymers with xylene cold soluble (XCS) content in the range 2-31 Wt.-%. The determined XS calibration is linear

wt.-% XCS=1.01*wt. % SF (Equation 4):

Intrinsic viscosity (IV) of the parent EP copolymer and its soluble fraction (SF) and crystalline fraction (CF) are determined with a use of an online 2-capillary viscometer and are correlated to corresponding IV's determined by standard method in decalin according to ISO 1628-3.

Calibration is achieved with several commercial EP PP copolymers with IV=2-4 dL/g. The determined calibration curve between the Vsp, measured in CRYSTEX QC and normalized by the concentration (c), and the IV is linear (Equation 5):

IV (dl/g)=a*Vsp/c

with a slope of a=16.2.

A sample of the PO composition to be analysed is weighed out in concentrations of 10 mg/ml to 20 mg/ml. After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm to 800 rpm. To avoid sample degradation, polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV[dl/g] and the C2[wt. %] of the PO composition. During the second injection the soluble fraction (SF, at low temperature, 40° C.) and the crystalline fraction (CF, at high temperature, 160° C.) with the crystallization cycle are determined (Wt.-% SF, Wt.-% C2, IV).

### ¹³C NMR Spectroscopy-Based Determination of C2 Content for the Calibration Standards

Quantitative ¹³C{¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium (III) acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225, Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed (Cheng, H. N., Macromolecules 17 (1984), 1950) and the comonomer fraction calculated as the fraction of ethylene in the polymer with respect to all monomer in the polymer:

fE=(E/(P+E))

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents. For systems with very low ethylene content where only isolated ethylene in PPEPP sequences were observed the method of Wang et. al. was modified reducing the influence of integration of sites that are no longer present. This approach reduced the overestimation of ethylene content for such systems and was achieved by reduction of the number of sites used to determine the absolute ethylene content to

E=0.5(Sββ+Sβγ+Sβδ+0.5(Sαβ+Sαγ))

Through the use of this set of sites the corresponding integral equation becomes

E=0.5(I_{H}+I_{G}+0.5(I_{C}+I_{D}))

using the same notation used in the article of Wang et. al. (Wang, W-J., Zhu, S., Macromolecules 33 (2000), 1157). Equations used for absolute propylene content were not modified. The mole percent comonomer incorporation was calculated from the mole fraction:

E[mol %]=100*fE.

The weight percent comonomer incorporation was calculated from the mole fraction:

E[wt %]=100*(fE*28.06)/((fE*28.06)+((1−fE)*42.08))

### j) Rheology

Dynamic rheological measurements were carried out with Rheometrics RDA-II QC on compression molded samples under nitrogen atmosphere at 200° C. using 25 mm—diameter plate and plate geometry. The oscillatory shear experiments were done within the linear viscoelastic range of strain at frequencies from 0.01 to 500 rad/s. (ISO6721-1)

The values of storage modulus (G′) loss modulus (G″), complex modulus (G*) and complex viscosity (η*) were obtained as a function of frequency (ω).

The Zero shear viscosity (η₀) was calculated using complex fluidity defined as the reciprocal of complex viscosity. Its real and imaginary part are thus defined by

f′(ω)=η′(ω)/[η′(ω)²+η″(ω)²] and

f″(ω)=η″(ω)/[η′(ω)²+η″(ω)²]

From the following equations

n′=G″/ω and η″=G′/ω

f′(ω)=G″(ω)*ω/[G′(ω)²+G″(ω)²]

f″(ω)=G′(ω)*ω/[G′(ω)²+G″(ω)²]

The polydispersity index, PI, =10⁵/Gc, is calculated from cross-over point of G′(ω) and G″(ω), for which G′(ωc)=G″(ωc)=Gc holds.

### Materials

Purpolen PP is a post-consumer recyclate polypropylene based material available from MTM plastics having a density (determined according to DIN EN ISO 1183) of 916 kg/m³, a melt flow rate (determined according to DIN EN ISO 1133, 230° C./2.16 kg) of 36 g/10 min, a moister content (determined via a moister infrared analyzer, 105° C.) of less than 0.1%, a tensile modulus (determined according to DIN EN ISO 527, 1 mm/min) of more than 1100 MPa, a yield stress (determined according to DIN EN ISO 527, 50 mm/min) of more than 24 MPa, and a tensile strain (determined according to DIN EN ISO 527, 50 mm/min) of more than 18%.

TABLE 1
PCR material properties

| | Purpolen | Dipolen | Dipolen |
|---|---|---|---|
| | PP | PP | S |
| Total C2 content (wt.-%) | 10.6 | 9.7 | 44.9 |
| Limonene content (ppm) | n.m. | 16 | 20 |
| MFR₂ (g/10 min), 230° C. | 36 | 14.1 | 5.3 |
| Density (kg/m³) | 916 | 920 | 940 |
| PI (Pa⁻¹) | 2.98 | 3.19 | 3.42 |
| eta_{0.05} (Pa · s) | 1527 | 3215 | 5699 |
| eta₃₀₀ (Pa · s) | 208 | 261 | 242 |
| Soluble fraction (wt.-%) | 13.7 | 8.7 | 9.1 |
| C2 content in soluble fraction | 32.2 | 30.1 | 46.0 |
| (wt.-%) | | | |
| C2 content in crystalline fraction | 7.0 | 8.4 | 45.5 |
| (wt.-%) | | | |
| Intrinsic viscosity soluble fraction | 2.1 | 1.3 | 1.4 |
| (dL/g) | | | |
| Intrinsic viscosity crystalline | 1.6 | 1.8 | 1.9 |
| fraction (dL/g) | | | |

n.m.—not measured

Dipolen S is a polyblend of post-consumer recyclate polyethylene based material with post-consumer recyclate polypropylene based material available from MTM plastics having a density (determined according to DIN EN ISO 1183) of 940 kg/m³, a melt flow rate (determined according to DIN EN ISO 1133, 230° C./2.16 kg) of 5.3 g/10 min, a moister content (determined via a moister infrared analyzer, 105° C.) of less than 0.1%, a tensile modulus (determined according to DIN EN ISO 527, 1 mm/min) of more than 820 MPa, a yield stress (determined according to DIN EN ISO 527, 50 mm/min) of more than 20 MPa, and a tensile strain (determined according to DIN EN ISO 527, 50 mm/min) of more than 150%.

Dipolen PP is a post-consumer recyclate polypropylene based material available from MTM plastics having a density (determined according to DIN EN ISO 1183) of 920 kg/m³, a melt flow rate (determined according to DIN EN ISO 1133, 230° C./2.16 kg) of 14.1 g/10 min, a moister content (determined via a moister infrared analyzer, 105° C.) of less than 0.1%, a tensile modulus (determined according to DIN EN ISO 527, 1 mm/min) of more than 1100 MPa, a yield stress (determined according to DIN EN ISO 527, 50 mm/min) of more than 25 MPa, and a tensile strain (determined according to DIN EN ISO 527, 50 mm/min) of more than 180%.

HL712FB (CAS 9003-07-0) is a polypropylene homopolymer available from Borealis having a melt flow rate (determined according to DIN EN ISO 1133, 230° C./2.16 kg) of 1,200 g/10 min and a melting temperature (DSC, determined according to ISO 11357-3) of 158° C.

Queo 8230 is an ethylene based 1-octene plastomer, produced in a solution polymerisation process using a metallocene catalyst available from Borealis having a melt flow rate (MFR₂; determined according to DIN EN ISO 1133, 190° C./2.16 kg) of 30 g/10 min, a density (ρ; determined according to DIN EN ISO 1183) of 883 kg/m³, a melting temperature (DSC, determined according to ISO 11357-3) of 76° C., and a Vicat softening temperature (10N, determined according to ISO 306) of 43° C.

Queo 6800LA is an ethylene based 1-octene plastomer, produced in a solution polymerisation process using a metallocene catalyst available from Borealis having a melt flow rate (MFR₂; determined according to DIN EN ISO 1133, 190° C./2.16 kg) of 0.5 g/10 min, a density (ρ; determined according to DIN EN ISO 1183) of 868 kg/m³, a melting temperature (DSC, determined according to ISO 11357-3) of 47° C., and a Vicat softening temperature (10N, determined according to ISO 306) of 38° C.

Queo 7007LA is an ethylene based 1-octene plastomer, produced in a solution polymerisation process using a metallocene catalyst available from Borealis having a melt flow rate (MFR₂; determined according to DIN EN ISO 1133, 190° C./2.16 kg) of 6.6 g/10 min, a density (ρ; determined according to DIN EN ISO 1183) of 870 kg/m³, a melting temperature (DSC, determined according to ISO 11357-3) of 48° C., and a Vicat softening temperature (10N, determined according to ISO 306) of 35° C.

HE0880-A is a carbon black containing polyethylene comprising approximately 40 wt.-% of carbon black (having a pour (bulk) density, determined according to ASTM D1513, from 330 to 430 g/l and a mean primary particle size, determined according to ASTM D3849, from 11 to 20 nm) and approximately 60 wt.-% of virgin polyethylene, each based on the total weight of the carbon black containing polyethylene having a melt flow rate (MFR₂₁; determined according to DIN EN ISO 1133, 190° C./21.6 kg) of 45 g/10 min.

### EXPERIMENTS

Compositions were prepared via melt blending on a co-rotating twin screw extruder (ZSK) according to the recipes given in Tables 2 to 5 (it is to be understood that the component's values denote wt.-%). The polymer melt mixture was discharged and pelletized. The mechanical properties of the compositions are also given in Tables 2 to 5.

TABLE 2
Comparative Examples, wherein the polypropylene composition comprises
a PCR polyolefin and optionally a carbon black containing polyethylene.

| | | | | | | | | |
|---|---|---|---|---|---|---|---|---|
| CE1 | CE2 | CE3 | CE4* | CE5* | CE6* | CE7* | CE8* | CE9* |

Composition

| | | | | | | | | | |
|---|---|---|---|---|---|---|---|---|---|
| Dipolen S | 99.85 | — | — | — | — | — | — | — | — |
| (MFR₂ = 5.3 g/10 min) | | | | | | | | | |
| Purpolen PP | — | — | 99.85 | 79.85* | 84.85* | 99.85 | — | — | — |
| (MFR₂ = 36 g/10 min) | | | | | | | | | |
| Dipolen PP | — | 99.85 | — | — | — | — | 79.85* | 84.85* | 99.85* |
| (MFR₂ = 14.1 g/10 min) | | | | | | | | | |
| HE0880-A | — | — | — | 20 | 15 | — | 20 | 15 | — |
| Stabilisers | 0.15 | 0.15 | 0.15 | 0.15 | 0.15 | 0.15 | 0.15 | 0.15 | 0.15 |

Properties

| | | | | | | | | | |
|---|---|---|---|---|---|---|---|---|---|
| MFR₂ | 5.6 | 15.8 | 33.4 | 14.2 | 15.9 | 22.6 | 8.4 | 9.4 | 12.0 |
| [g/10 min] | | | | | | | | | |
| Volume Resistivity | —** | —** | —** | 1581 | —** | —** | 1707 | —** | —** |
| [Ohm · cm] | | | | | | | | | |
| Tensile Modulus, | 865 | 1253 ± | 1309 ± | 1340 | 1310 | 1260 | 1300 | 1260 | 1210 |
| [MPa] | | 3 | 4 | | | | | | |
| Charpy NIS | 5.2 ± | 5.2 ± | 5.3 ± | 6.7 ± | 6.4 ± | 6.0 ± | 5.7 ± | 5.7 ± | 5.9 ± |
| [kJ/m²] | 0.5 | 0.6 | 0.3 | 0.3 | 0.3 | 0.3 | 0.6 | 0.5 | 0.5 |

*different lot of the same PCR material was used, i.e. different MFR values between the lots, and slightly different of mechanical performance (tensile modulus & Charpy impact)
**not measurable (value too high)

TABLE 3
Inventive and Comparative Examples, wherein the polypropylene composition
comprises a PCR polypropylene, a carbon black containing polyethylene
(HE0880-A), and a C2C8 copolymer, if present.

| | | | | | | | |
|---|---|---|---|---|---|---|---|
| CE10* | CE11 | IE1 | IE2 | CE12* | CE13 | IE3 | IE4 |

Composition

| | | | | | | | | |
|---|---|---|---|---|---|---|---|---|
| Purpolen PP | 59.85 | 59.85 | 54.85 | 59.85 | — | — | — | — |
| (MFR₂ = 36 g/10 min) | | | | | | | | |
| Dipolen PP | — | — | — | — | 59.85 | 59.85 | 54.85 | 59.85 |
| (MFR₂ = 14.1 g/10 min) | | | | | | | | |
| HE0880-A | 40 | 40 | 35 | 30 | 40 | 40 | 35 | 30 |
| C2C8 Queo 8230 | — | — | — | — | — | — | 10 | — |
| (ρ = 883 kg/m³, | | | | | | | | |
| MFR₂ = 30 g/10 min) | | | | | | | | |
| C2C8 Queo 6800LA | — | — | — | 10 | — | — | — | — |
| (ρ = 868 kg/m³, | | | | | | | | |
| MFR₂ = 0.5 g/10 min) | | | | | | | | |
| C2C8 Queo 7007LA | — | — | 10 | — | — | — | — | 10 |
| (ρ = 870 kg/m³, | | | | | | | | |
| MFR₂ = 6.6 g/10 min) | | | | | | | | |
| Stabilisers | 0.15 | 0.15 | 0.15 | 0.15 | 0.15 | 0.15 | 0.15 | 0.15 |

Properties

| | | | | | | | | |
|---|---|---|---|---|---|---|---|---|
| MFR₂ | 7.9 | 9.4 | 10.9 | 10.3 | 5.1 | 5.4 | 7.0 | 7.4 |
| [g/10 min] | | | | | | | | |
| Volume Resistivity | 30 | 16 | 62 | 16 | 21 | 15 | 37 | 84 |
| [Ohm · cm] | | | | | | | | |
| Tensile Modulus | 1550 | 1595 ± | 1138 ± | 1119 ± | 1500 | 1557 ± | 1161 ± | 1103 ± |
| [MPa] | | 3 | 5 | 3 | | 3 | 4 | 2 |
| Charpy NIS | 4.8 ± | 4.6 ± | 20.0 ± | 34.7 ± | 4.0 ± | 3.9 ± | 6.4 ± | 15.8 ± |
| [kJ/m²] | 0.3 | 0.4 | 1.3 | 1.8 | 0.5 | 0.1 | 0.3 | 1.2 |

*different lot of the same PCR material was used, i.e. different MFR values between the lots, and slightly different of mechanical performance (tensile modulus & Charpy impact)

TABLE 4
Inventive and Comparative Examples, wherein the polypropylene composition
comprises a PCR polypropylene or a blend of a PCR polypropylene with
a PCR polyethylene, a carbon black containing polyethylene (HE0880-
A), a C2C8 copolymer, and optionally a polypropylene material.

| | | | | | |
|---|---|---|---|---|---|
| CE14 | CE15 | IE7 | IE8 | IE9 | IE10 |

Composition

| | | | | | | |
|---|---|---|---|---|---|---|
| Dipolen S | 54.85 | 59.85 | 36.3 | 39.1 | 22.4 | 24.9 |
| (MFR₂ = 5.3 g/10 min) | | | | | | |
| Purpolen PP | — | — | — | — | 22.4 | 24.9 |
| (MFR₂ = 36 g/10 min) | | | | | | |
| HE0880-A | 35 | 30 | 40 | 35 | 39 | 33 |
| C2C8 Queo 8230LA | 10 | 10 | — | — | — | — |
| (ρ = 883 kg/m³, | | | | | | |
| MFR₂ = 30 g/10 min) | | | | | | |
| C2C8 Queo 6800LA | — | — | — | 10 | — | 10 |
| (ρ = 868 kg/m³, | | | | | | |
| MFR₂ = 0.5 g/10 min) | | | | | | |
| C2C8 Queo 7007LA | — | — | 10 | — | 10 | — |
| (ρ = 870 kg/m³, | | | | | | |
| MFR₂ = 6.6 g/10 min) | | | | | | |
| stabilisers | 0.15 | 0.15 | 0.2 | 0.2 | 0.2 | 0.2 |
| HL712FB | — | — | 13.5 | 15.7 | 6 | 7 |

Properties

| | | | | | | |
|---|---|---|---|---|---|---|
| MFR₂ | 4.1 | 4.3 | 8.1 | 8.4 | 8.4 | 8.7 |
| [g/10 min] | | | | | | |
| Volume Resistivity | 137 | 221 | 159 | 1335 | 77 | 236 |
| [Ohm · cm] | | | | | | |
| Tensile Modulus | 920 | 892 | 1096 | 1018 | 1098 ± | 1048 ± |
| [MPa] | | | | | 2 | 2 |
| Charpy NIS | 4.9 ± | 5.5 ± | 12.4 | 26.5 | 20.3 ± | 24.5 ± |
| [kJ/m²] | 0.4 | 0.2 | | | 1.1 | 0.8 |

TABLE 5
Inventive Examples, wherein the polypropylene composition comprises
a PCR polypropylene with a PCR polyethylene (Dipolen S), a carbon
black containing polyethylene (HE0880-A), a C2C8 copolymer, and
a polypropylene material. The Dipolen S used for IE11 and IE12
had equal properties as outlined in Table 1 above, but an MFR
of 5.8 g/10 min and an eta0.05 (Pa · s) of 6915 Pa · s.

| | IE11 | IE12 |
|---|---|---|
| Dipolen S (MFR₂ = 5.8 g/10 min) | 36.3 | 39.1 |
| HE0880-A | 40 | 35 |
| CB content, wt % | 16.1 | 14.5 |
| Queo 6800LA (ρ = 868 kg/m³, | — | 10 |
| MFR₂ = 0.5 g/10 min) | | |
| Queo 7007LA (ρ = 870 kg/m³, | 10 | — |
| MFR₂ = 6.6 g/10 min) | | |
| Stabilisers | 0.2 | 0.2 |
| HL712FB (MFR~1200) | 13.5 | 15.7 |
| Properties | | |
| MFR(230° C./2.16 kg) [g/10 min] | 8.1 | 8.4 |
| Volume Resistivity [Ohm · cm] | 159 | 1335 |
| Tensile Modulus [MPa] | 1096 ± 4 | 1018 ± 4 |
| Charpy NIS at +23° C. [kJ/m²] | 12.4 ± 0.7 | 26.5 ± 1.1 |

It can be seen that the inventive polypropylene compositions provide not only a sufficient Volume Resistivity having a maximum of 236 Ohm·cm but also a satisfactory MFR₂ value between 4.1 and 10.3 g/10 min. Further, sufficient Tensile Modulus and Charpy NIS values are provided by the inventive polypropylene compositions. When comparing e.g. CE11 with IE1, it can be seen that the addition of the C2C8 copolymer (Queo 7007LA) and reduction of HE0880-A only slightly increases the Volume Resistivity from 16 to 62 Ohm·cm. Also, the Tensile Modulus is still in a preferred range. The MFR₂ and the Charpy NIS values however improve. In particular, the improved impact performance is of great advantage with regards to the electroconductive boxes, crates, or pellets.

1. A polyolefin composition obtainable by blending:
a) 10 to 74 wt.-% of at least one post-consumer recyclate polyolefin based material (PCR-PO1) having a melt flow rate (ISO 1133, 2.16 kg, 230° C.) of 1 to 50 g/10 min and a Volume Resistivity (determined according to ISO 3915 at a temperature of 23° C. and 50% relative humidity) of more than 1800 Ohm·cm,
b) optionally 10 to 50 wt.-% of at least one further, different post-consumer recyclate polyolefin based material (PCR-PO2) having a melt flow rate (ISO 1133, 2.16 kg, 230° C.) of 1 to 50 g/10 min and a Volume Resistivity (determined according to ISO 3915 at a temperature of 23° C. and 50% relative humidity) of more than 1800 Ohm·cm,
c) 25 to 55 wt.-% of a carbon black containing polyolefin (CB PO),
d) 1 to 30 wt.-% of at least one C2C4, C2C6, or C2C8 copolymer with a density (determined according to DIN EN ISO 1183) of 860-890 kg/m³ and a melt flow rate (ISO 1133, 2.16 kg, 190° C.) of 0.3 to 35.0 g/10 min,
each based on the total weight of the polyolefin composition,
wherein the polyolefin composition has a Volume Resistivity (determined according to ISO 3915 at a temperature of 23° C. and 50% relative humidity) from 5 to 1400 Ohm·cm and a melt flow rate (ISO 1133, 2.16 kg, 230° C.) of 7 to 20 g/10 min, and
wherein the polyolefin composition comprises a total of 10 to 23 wt.-% of carbon black, based on the total weight of the polyolefin composition.

2. The polyolefin composition according to claim 1, wherein the components are blended in the following amounts:
a) 13 to 71 wt.-% of the at least one post-consumer recyclate polyolefin based material (PCR-PO1),
b) optionally 13 to 45 wt.-% of the at least one further, different post-consumer recyclate polyolefin based material (PCR-PO2),
c) 26 to 51 wt.-% of the carbon black containing polyolefin (CB PO),
d) 3 to 25 wt.-% of the at least one C2C4, C2C6, or C2C8 copolymer,
each based on the total weight of the polyolefin composition.

3. The polyolefin composition according to claim 1, wherein the at least one post-consumer recyclate polyolefin based material (PCR-PO1) is selected from the group consisting of post-consumer recyclate polypropylene based material (PCR-PP1), post-consumer recyclate polyethylene based material (PCR-PE1), and blends thereof.

4. The polyolefin composition according to claim 1, wherein the components are blended in the following amounts:
a) from 30 to 70 wt. % of the at least one post-consumer recyclate polyolefin based material (PCR-PO1) being a post-consumer recyclate polypropylene based material (PCR-PP1) comprising a total amount of propylene units (C3 units) of from 80.0 wt.-% to 99.0 wt. %, based on the total weight of the PCR-PP1,
b) optionally from 10 to 40 wt. % of the at least one further, different post-consumer recyclate polyolefin based material (PCR-PO2),
c) from 25 to 55 wt. % of the carbon black containing polyolefin (CB PO),
d) from 5 to 20 wt. % of the at least one C2C4, C2C6, or C2C8 copolymer,
wherein the amounts of PCR-PO1, PCR-PO2, the carbon black containing polyolefin (CB PO), and the copolymer are each based on the total weight of the polyolefin composition.

5. The polyolefin composition according to claim 1, wherein the components are blended in the following amounts:
a) from 15 to 40 wt. % of the at least one post-consumer recyclate polyolefin based material (PCR-PO1) being a post-consumer recyclate polypropylene based material (PCR-PP1) comprising a total amount of propylene units (C3 units) of from 80.0 wt.-% to 99.0 wt. % based on the total weight of the PCR-PP1,
b) from 15 to 40 wt. % of the at least one further, different post-consumer recyclate polyolefin based material (PCR-PO2),
c) from 25 to 55 wt. % of the carbon black containing polyolefin (CB PO),
d) from 5 to 20 wt. % of the at least one C2C4, C2C6, or C2C8 copolymer,
wherein the amounts of PCR-PO1, PCR-PO2, the carbon black containing polyolefin (CB PO), and the copolymer are each based on the total weight of the polyolefin composition.

6. The polyolefin composition according to claim 1, wherein the at least one post-consumer recyclate polyolefin based material (PCR-PO1) has:
a soluble fraction (SF, determined according to CRYSTEX QC method ISO 6427 Annex B), present in an amount in the range from 5.0 to 40.0 wt.-%, relative to the total weight of the at least one PCR-PO1,
and/or
a crystallization temperature (determined according to ISO 11357/part 3/10K/min) of 110 to 140° C.,
and/or
a density (determined according to DIN EN ISO 1183) of 900 to 956 kg/m³
and/or
a melt flow rate (ISO 1133, 2.16 kg, 230° C.) of 4 to 38 g/10 min.

7. The polyolefin composition according to claim 1, wherein the at least one post-consumer recyclate polyolefin based material (PCR-PO1) comprises less than 10 wt. % of a metal (determined by x ray fluorescence (XRF)), based on the total weight of the at least one post-consumer recyclate polyolefin based material (PCR-PO1) and/or
has at least one of the following:
a content of limonene of from 0.1 to 500 ppm (as determined using solid phase microextraction (HS-SPME-GC-MS) by standard addition);
a content of polystyrene of up to 6.0 wt.-%;
a content of talc of up to 3 wt.-%;
a content of chalk of up to 1.0 wt.-%;
a content of polyamide(s) of up to 5.0 wt.-%;
a content of fatty acids (as determined using solid phase microextraction (HS-SPME-GC-MS) by standard addition) of 1.0 to 100 ppm.

8. The polyolefin composition according to claim 1, comprising a total of 11 to 21 wt. % of carbon black, based on the total weight of the polyolefin composition.

9. The polyolefin composition according to claim 1, wherein the carbon black containing polyolefin (CB PO) comprises a carbon black containing polyethylene.

10. The polyolefin composition according to claim 1, wherein the copolymer is a C2C8 copolymer comprising ethylene units and 1 octene unit.

11. The polyolefin composition according to claim 1, wherein the at least one C2C4, C2C6, or C2C8 copolymer has a melting temperature (DSC, determined according to ISO 11357-3) of 35 to 85° C. and/or
a Vicat softening temperature (10N, determined according to ISO 306) of 27 to 50° C.

12. The polyolefin composition according to claim 1, obtainable by blending with additionally:
e) 1 to 25 wt.-%, based on the total weight of the polyolefin composition, of a polyolefin material.

13. The polyolefin composition according to claim 1, wherein the polyolefin composition comprises less than 10 wt. % of aluminum (determined by x ray fluorescence (XRF)), based on the total weight of the polyolefin composition and/or
wherein the polyolefin composition has a melt flow rate (ISO 1133, 2.16 kg, 230° C.) of 7 to 15 g/10 min.

14. Electroconductive boxes, crates, or pellets comprising a polyolefin composition, which is produced from at least one post-consumer recyclate polyolefin based material (PCR-PO1) and more than 20 wt.-% of a carbon black containing polyolefin (CB PO), based on the total weight of the polyolefin composition.

15. (canceled)

16. The polyolefin composition according to claim 9, wherein the carbon black containing polyolefin (CB PO) comprises at least 50 wt.-% of polyethylene, based on the total weight of the carbon black containing polyolefin (CB PO).

17. The polyolefin composition according to claim 10, wherein the C2C8 copolymer is produced in a solution polymerisation process using a metallocene catalyst.

18. The polyolefin composition according to claim 1, obtainable by blending with additionally:
e) 1 to 25 wt.-%, based on the total weight of the polyolefin composition, of a polyolefin material having a melt flow rate (ISO 1133, 2.16 kg, 190° C.) of 800 to 1600 g/10 min and/or a melting temperature (DSC, determined according to ISO 11357-3) from 145 to 170° C.
